(19) United States
(12) Patent Application Publication
(10) Pub. No.: US 2026/0329206 A1
(43) Pub. Date: Oct. 22, 2026

(54) IMAGE FORMING APPARATUS AND CONTROL METHOD OF IMAGE FORMING APPARATUS

(71) Applicant: SHARP KABUSHIKI KAISHA, Osaka (JP)

(72) Inventor: Yuichi KAKU, Osaka (JP)

(21) Appl. No.: 19/560,429

(22) Filed: Mar. 9, 2026

(30) Foreign Application Priority Data
Mar. 19, 2025 (JP) 2025-044784

(51) Int. Cl. G03G 15/16; G03G 15/00; G03G 15/01

(52) U.S. Cl. CPC G03G 15/1615; G03G 15/0131; G03G 15/0189; G03G 15/5004; G03G 15/505

(57) ABSTRACT

An image forming apparatus includes a photosensitive drum, an intermediate transfer member, a driver that drives the intermediate transfer member at a variable driving speed, a first potential applier that applies a first potential to the intermediate transfer member to transfer a toner image from the photosensitive drum to the intermediate transfer member, and a controller. The controller causes the first potential applier to stop applying the first potential to the intermediate transfer member during a first period that is started based on a timing at which the driver changes a driving speed of the intermediate transfer member. The first period is determined based on a period during which the photosensitive drum makes one rotation.

### BACKGROUND OF THE INVENTION

### Field of the Invention

The present disclosure relates to an image forming apparatus and the like.

### Description of the Background Art

In general, in an image forming apparatus capable of switching and printing a plurality of types of sheets having different thicknesses, a driving speed of a primary transfer belt is changed when the type of sheet is switched. There is an image forming apparatus that switches a frequency of a high-output AC voltage to be applied to a photosensitive drum in accordance with a sheet type when a driving speed of a primary transfer belt is changed. Further, there is an image forming apparatus that initializes a laser scanning unit (LSU) when a driving speed of a primary transfer belt is changed.

In relation to the present disclosure, in a conventional art, there is known a method for transferring toner on a photosensitive drum to an intermediate transfer belt, then transferring the toner to a print sheet by a secondary transfer roller, and then fixing the toner on the print sheet by a fixing roller.

Further, in relation to the present disclosure, in a conventional art, there is known an image forming apparatus capable of printing on a plurality of types of sheets such as plain paper and thick paper, in which a conveyance speed is controlled in accordance with the type and physical properties of a sheet when an image is fixed on the sheet.

When a frequency of a high-output AC voltage applied to a photosensitive drum is switched, the phase of a waveform of AC current collapses. Consequently, an instantaneous potential change may occur on the surface of the photosensitive drum, and an electrostatic latent image may be formed. In addition, when the LSU is initialized, the LSU is forced to emit light, but the light at this time may cause an instantaneous potential change on the surface of the photosensitive drum, and an electrostatic latent image may be formed. As described above, an electrostatic latent image may be formed on the surface of the photosensitive drum for a reason other than generation of an electrostatic latent image by exposure irradiation. In the conventional image forming apparatus, the electrostatic latent image formed on the surface of the photosensitive drum due to the instantaneous potential change may cause adhesion of unnecessary toner to the photosensitive drum, which may deteriorate print quality.

An object of the present disclosure is to provide an image forming apparatus with improved print quality.

### SUMMARY OF THE INVENTION

The present disclosure provides an image forming apparatus including: a photosensitive drum; an intermediate transfer member; a driver that drives the intermediate transfer member at a variable driving speed; a first potential applier that applies a first potential to the intermediate transfer member to transfer a toner image from the photosensitive drum to the intermediate transfer member; and one or more controllers. The one or more controllers cause the first potential applier to stop applying the first potential to the intermediate transfer member during a first period that is started based on a timing at which the driver changes a driving speed of the intermediate transfer member. The first period is determined based on a period during which the photosensitive drum makes one rotation.

Further, the present disclosure provides a control method of an image forming apparatus provided with a photosensitive drum, an intermediate transfer member, a driver that drives the intermediate transfer member at a variable driving speed, and a first potential applier that applies a first potential to the intermediate transfer member to transfer a toner image from the photosensitive drum to the intermediate transfer member. The control method includes causing the first potential applier to stop applying the first potential to the intermediate transfer member during a first period that is started based on a timing at which the driver changes a driving speed of the intermediate transfer member. The first period is determined based on a period during which the photosensitive drum makes one rotation.

According to the present disclosure, it is possible to provide an image forming apparatus with improved print quality.

### BRIEF DESCRIPTION OF THE DRAWINGS

FIG. 1 is an external perspective view of an image forming apparatus according to a first embodiment of the present disclosure.

FIG. 2 is a block diagram of the image forming apparatus according to the first embodiment of the present disclosure.

FIG. 3 is a block diagram of an image former of the image forming apparatus according to the first embodiment of the present disclosure.

FIG. 4 is a block diagram of a controller of the image forming apparatus according to the first embodiment of the present disclosure.

FIG. 5 is a block diagram of a storager of the image forming apparatus according to the first embodiment of the present disclosure.

FIG. 6 is a diagram for explaining an example of a structure of a sheet type setting table stored in a sheet type setting storage.

FIG. 7 is a flowchart for describing an operation of the image forming apparatus according to the first embodiment of the present disclosure.

FIG. 8 is a flowchart for describing color job processing of the image forming apparatus according to the first embodiment of the present disclosure.

FIG. 9 is a flowchart for describing monochrome job processing of the image forming apparatus according to the first embodiment of the present disclosure.

FIGS. 10A and 10B are conceptual schematic diagrams for explaining a contact/separation operation of CMY photosensitive drums in the image forming apparatus according to the first embodiment of the present disclosure, in which FIG. 10A is a diagram illustrating a state in which the CMY photosensitive drums are in contact with a primary transfer belt, and FIG. 10B is a diagram illustrating a state in which the CMY photosensitive drums are away from the primary transfer belt.

FIGS. 11A to 11D are conceptual schematic diagrams for explaining transfer of streaks adhering to the primary transfer belt from CMYK photosensitive drums in the image forming apparatus according to the first embodiment of the present disclosure, in which FIG. 11A illustrates toner that adheres to a primary transfer belt 170H from the CMYK photosensitive drums immediately after switching of frequencies of high-output AC voltages applied to the photosensitive drums or forced lighting of an LSU 170A, which becomes streak contamination, and FIGS. 11B to 11D each illustrates transfer of streak contamination when the primary transfer belt 170H is driven in a forward direction from the state in FIG. 11A.

FIG. 12 is a schematic conceptual diagram for explaining a relationship among a distance by which the primary transfer belt is idly rotated, a primary transfer position, and a secondary transfer position in the image forming apparatus according to the first embodiment of the present disclosure.

FIG. 13 is a flowchart for describing color job processing of the image forming apparatus according to the first embodiment of the present disclosure.

FIG. 14 is a flowchart for describing monochrome job processing of the image forming apparatus according to a modification of the first embodiment of the present disclosure.

FIG. 15 is a flowchart for describing monochrome job processing of an image forming apparatus according to a second embodiment of the present disclosure.

FIG. 16 is a block diagram of an image former of an image forming apparatus according to a third embodiment of the present disclosure.

FIG. 17 is a flowchart for describing color job processing of the image forming apparatus according to the third embodiment of the present disclosure.

FIG. 18 is a flowchart for describing monochrome job processing of the image forming apparatus according to the third embodiment of the present disclosure.

FIG. 19 is a flowchart for describing monochrome job processing of an image forming apparatus according to a fourth embodiment of the present disclosure.

FIG. 20 is a flowchart for describing color job processing of an image forming apparatus according to a fifth embodiment of the present disclosure.

FIG. 21 is a flowchart for describing monochrome job processing of the image forming apparatus according to the fifth embodiment of the present disclosure.

FIG. 22 is a schematic conceptual diagram for explaining an example of an elapse of time from execution of a last causal operation to start of formation of a latent image on CMYK photosensitive drums in the image forming apparatus according to the fifth embodiment of the present disclosure.

### DESCRIPTION OF THE PREFERRED EMBODIMENTS

Each of image forming apparatuses according to first to fifth embodiments described below can perform both color printing and monochrome printing, and includes four photosensitive drums, which are a C drum, an M drum, a Y drum, and a K drum each associated with cyan (C), magenta (M), yellow (Y), and black (key plate, K).

### 1. First Embodiment

An image forming apparatus according to a first embodiment is described. The image forming apparatus according to the first embodiment includes a CMY drum contact/separator 170G capable of moving a C photosensitive drum 170B, an M photosensitive drum 170C, and a Y photosensitive drum 170D toward or away from the primary transfer belt 170H. Further, frequencies of high-output AC voltages applied to the C photosensitive drum 170B, the M photosensitive drum 170C, and the Y photosensitive drum 170D, and a frequency of a high-output AC voltage applied to a K photosensitive drum 170E are different from each other (can be set independently of each other).

### 1.1. Overall Configuration

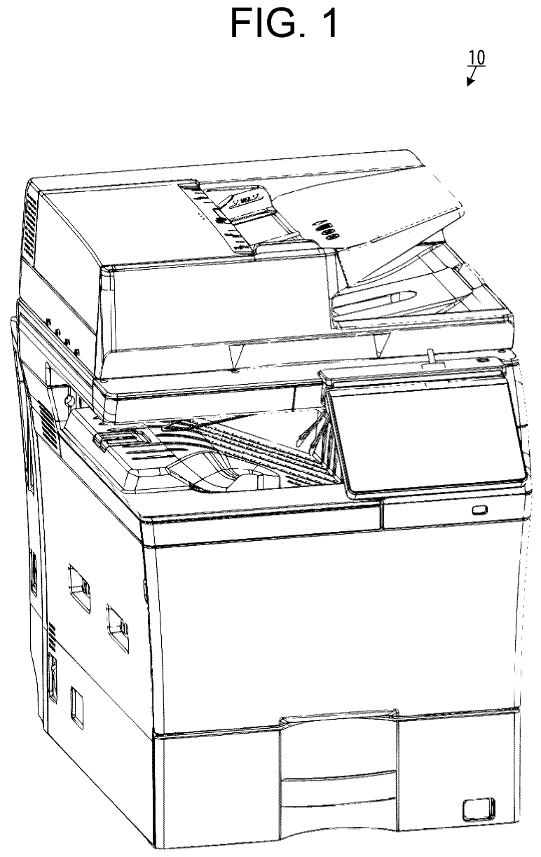

FIG. 1 is an external perspective view of an image forming apparatus 10 according to the first embodiment of the present disclosure. The image forming apparatus 10 is an image processing apparatus or an information processing apparatus also referred to as a multi-function printer/peripheral (MFP) or a multifunction machine, and typically has a copy function, an image scanner function, a facsimile function, and a printer function. The image forming apparatus may further include other functions, for example, an e-mail transmission/reception function, a file server function, and the like.

### 1.2 Hardware Configuration

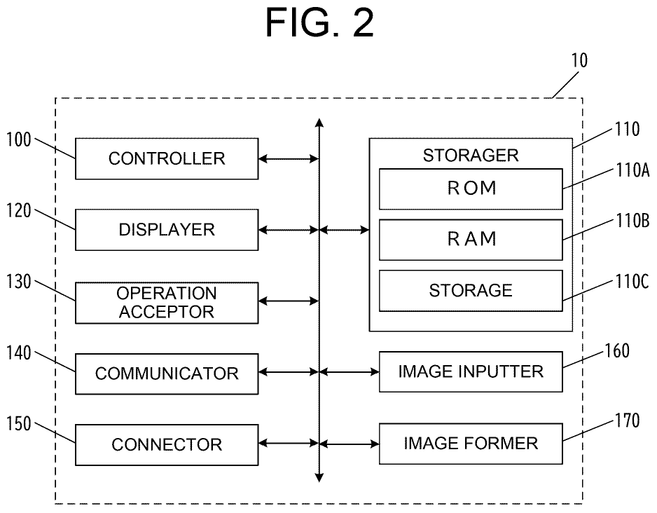

FIG. 2 is a functional block diagram of the image forming apparatus 10. The image forming apparatus 10 includes a controller 100, a displayer 120, an operation acceptor 130, a communicator 140, a connector 150, an image inputter 160, and an image former 170.

The controller 100 controls the entirety of the image forming apparatus 10. The controller 100 is composed of one or more control devices or one or more control circuits, and is composed of, for example, a central processing unit (CPU) that is a processor that executes various pieces of arithmetic processing, a system on a chip (SoC), or the like.

Further, the controller 100 reads and executes a program stored in a storager 110, thereby capable of achieving each function.

The controller 100 stores an operation history of the image forming apparatus 10 in an operation history storage 111 to be described later. The operation history includes contents of various operations performed by the image forming apparatus 10 and times at which the operations are performed. For example, the operation history includes a power-off time at which a main power supply is turned off, the number of single-sided printed sheets, and an execution time of single-sided printing.

The storager 110 stores various programs and various pieces of data, which are necessary for an operation of the image forming apparatus 10. The storager 110 includes one or more storage devices capable of transitory storage such as a dynamic random access memory (DRAM), or non-transitory storage devices, for example, such as a solid state drive (SSD) configured by a semiconductor memory or a hard disk drive (HDD) configured by a magnetic disk. Although the storager 110 is described as one configuration for convenience of explanation, the storager may be configured as individual devices for each purpose, such as an area (primary storage area) used for program execution, an area (auxiliary storage area) for storing programs and data, and an area used for caching.

The displayer 120 displays images and characters. For example, the displayer 120 is composed of a liquid crystal display (LCD), an organic electro-luminescence (EL) panel, or the like. The displayer 120 may be a single display device, or may further include a display device connected to the outside.

The operation acceptor 130 accepts an operation input from a user. For example, the operation acceptor 130 is composed of a hardware key and/or a software key. Further, the operation acceptor 130 includes operation keys such as a task key for giving an instruction to execute a task such as FAX transmission or image reading, and a cancel key for giving an instruction to stop an operation. Note that, the operation acceptor 130 can be configured as a touch panel that enables input via the displayer 120. In a case where the operation acceptor 130 is configured as a touch panel, it is possible to detect the user's touch, tap, swipe operation, and the like, on an object that is displayed via the displayer 120, and acquire coordinate information, pressure-sensitive information, and the like on touch panel information. In this case, as an input method of the touch panel, for example, a general input method such as a resistive film method, an infrared method, an electromagnetic induction method, or a capacitance method can be adopted.

The communicator 140 is connected to a network. For example, the communicator 140 is composed of an interface connectable to a wired local area network (LAN), a wireless LAN, or a long term evolution (LTE) network. When the communicator 140 is connected to the network, the communicator 140 is connected to another device or an external network. Further, the communicator 140 may be, for example, an interface that performs short-range wireless communications such as near field communication (NFC) or Bluetooth (registered trademark) other than the above.

The connector 150 connects the image forming apparatus 10 to another device. The connector 150 is, for example, a USB interface, to which a USB memory or the like is connected. Further, the connector 150 may be an interface such as HDMI (registered trademark) other than the USB interface.

The image inputter 160 reads an image (document), and outputs the read image as image data. The image inputter 160 is composed of a general scanner (image input device). Further, the image inputter 160 may receive image data from an external storage medium such as a USB memory, or may receive an image via a network.

The image former 170 forms (prints) an image on a recording medium including a sheet such as a copy sheet, based on image data. A printing system of the image former 170 is a laser printer. The image former 170 includes a plurality of unillustrated sheet accommodation units, each of which stores a different type of sheets (print media). Further, the image former 170 includes an unillustrated conveyor that selects one of the sheet accommodation units in accordance with an input from the operation acceptor 130 or the like, conveys a sheet stored in the selected sheet accommodation unit along a conveying path including a secondary transfer position to be described later, and discharges the sheet on which an image is formed at the secondary transfer position to a discharge tray.

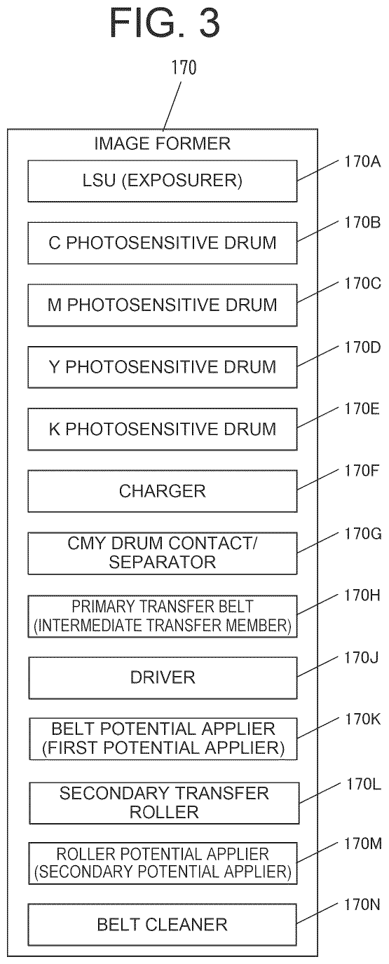

FIG. 3 is a block diagram of the image former 170 of the image forming apparatus 10 according to the first embodiment of the present disclosure. The image former 170 includes the LSU 170A, the C photosensitive drum 170B, the M photosensitive drum 170C, the Y photosensitive drum 170D, the K photosensitive drum 170E, a charger 170F, the CMY drum contact/separator 170G, the primary transfer belt 170H, a driver 170J, a belt potential applier 170K, a secondary transfer roller 170L, a roller potential applier 170M, and a belt cleaner 170N.

The LSU 170A is a laser scanning unit. The LSU 170A is also referred to as an exposurer. The LSU 170A irradiates the C photosensitive drum 170B, the M photosensitive drum 170C, the Y photosensitive drum 170D, and the K photosensitive drum 170E with a laser beam to form a latent image based on image data on each photosensitive drum.

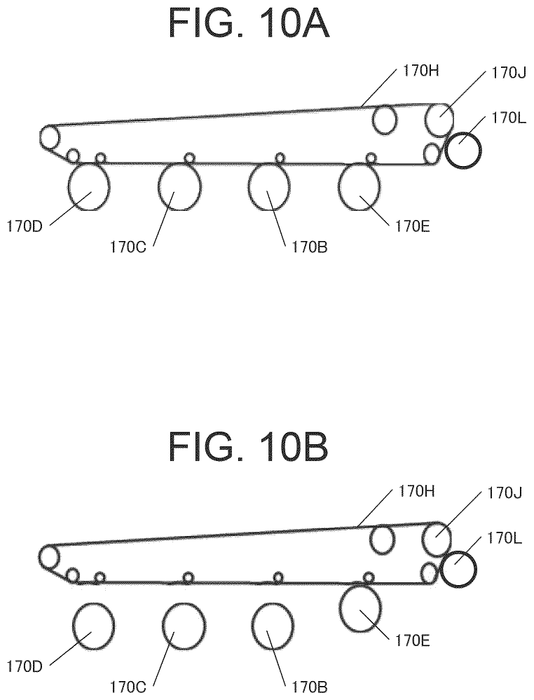

The C photosensitive drum 170B, the M photosensitive drum 170C, the Y photosensitive drum 170D, and the K photosensitive drum 170E are each a photosensitive drum of cyan (Cyan), magenta (Magenta), yellow (Yellow), and black (Key plate) in this order. As illustrated in FIGS. 10A and 10B and the like, in the present embodiment, the K photosensitive drum 170E, the C photosensitive drum 170B, the M photosensitive drum 170C, and the Y photosensitive drum 170D are disposed in series in this order from the closest side when viewed from the secondary transfer roller 170L. Note that, in the following description, the C photosensitive drum 170B, the M photosensitive drum 170C, the Y photosensitive drum 170D, and the K photosensitive drum 170E are collectively referred to as CMYK photosensitive drums or all the drums. Further, the C photosensitive drum 170B, the M photosensitive drum 170C, and the Y photosensitive drum 170D are collectively referred to as CMY photosensitive drums or color drums. The K photosensitive drum 170E is also referred to as a monochrome drum.

In the present specification, the primary transfer position is a position on the primary transfer belt 170H, and is a position facing a photosensitive drum. Positions facing the C photosensitive drum 170B, the M photosensitive drum 170C, the Y photosensitive drum 170D, and the K photosensitive drum 170E are each referred to as a primary transfer (C) position, a primary transfer (M) position, a primary transfer (Y) position, and a primary transfer (K) position in this order.

The charger 170F applies an AC voltage to each photosensitive drum, which is the C photosensitive drum 170B, the M photosensitive drum 170C, the Y photosensitive drum 170D, and the K photosensitive drum 170E. The charger 170F can change the frequency of the AC voltage to be applied. The charger 170F is also referred to as a second potential applier.

The CMY drum contact/separator 170G is a mechanism capable of moving the C photosensitive drum 170B, the M photosensitive drum 170C, and the Y photosensitive drum 170D toward or away from the primary transfer belt 170H to be described later. Note that, the K photosensitive drum 170E is constantly in contact with the primary transfer belt 170H.

The primary transfer belt 170H is an endless belt also referred to as an intermediate transfer member. The primary transfer belt 170H is stretched by a primary transfer driving roller and a primary transfer driven roller of the driver 170J to be described later, and circularly moves in a predetermined direction. The outer circumferential surface of the primary transfer belt 170H faces the C photosensitive drum 170B, the M photosensitive drum 170C, the Y photosensitive drum 170D, and the K photosensitive drum 170E.

The driver 170J includes the primary transfer driving roller and the primary transfer driven roller described above, and drives the primary transfer belt 170H to circularly move the primary transfer belt 170H. The driver 170J can circularly move the primary transfer belt 170H in a driving direction (forward direction) in which the primary transfer belt 170H is circularly moved at least at the time of printing, but may also circularly move the primary transfer belt 170H in a direction (reverse direction) opposite to the forward direction.

The belt potential applier 170K is also referred to as a first potential applier, and applies a first potential to the primary transfer belt 170H.

The secondary transfer roller 170L is configured to freely come close to or away from the primary transfer driving roller with the primary transfer belt 170H interposed therebetween. An area where the primary transfer belt 170H and the secondary transfer roller 170L come into press contact with each other is a secondary transfer area. In the present specification, a position on the primary transfer belt 170H and facing the secondary transfer roller 170L is referred to as the secondary transfer position.

The roller potential applier 170M applies a second potential to the secondary transfer roller 170L. The roller potential applier 170M is configured to be capable of reversing the polarity to be applied. A polarity applied to the secondary transfer roller 170L at the time of printing is referred to as a printing polarity, and a polarity opposite to the printing polarity is referred to as an opposite polarity.

The belt cleaner 170N removes toner adhering to the primary transfer belt 170H.

### 1.3 Software Configuration

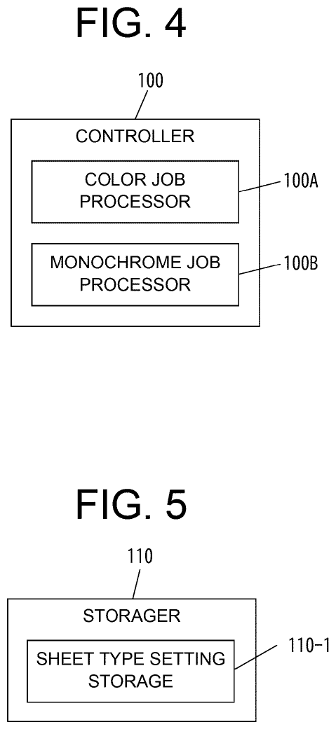

FIG. 4 is a block diagram of the controller 100 of the image forming apparatus 10 according to the first embodiment of the present disclosure. As described above, the controller 100 controls the entirety of the image forming apparatus 10, and the controller 100 particularly includes a color job processor 100A and a monochrome job processor 100B.

The color job processor 100A executes processing for color printing using the C photosensitive drum 170B, the M photosensitive drum 170C, the Y photosensitive drum 170D, and the K photosensitive drum 170E. The monochrome job processor 100B executes processing for monochrome printing using the K photosensitive drum 170E.

FIG. 5 is a block diagram of the storager 110 of the image forming apparatus 10 according to the first embodiment of the present disclosure. The storager 110 includes a sheet type setting storage 110-1. The sheet type setting storage 110-1 stores a sheet type setting table T1 to be described next.

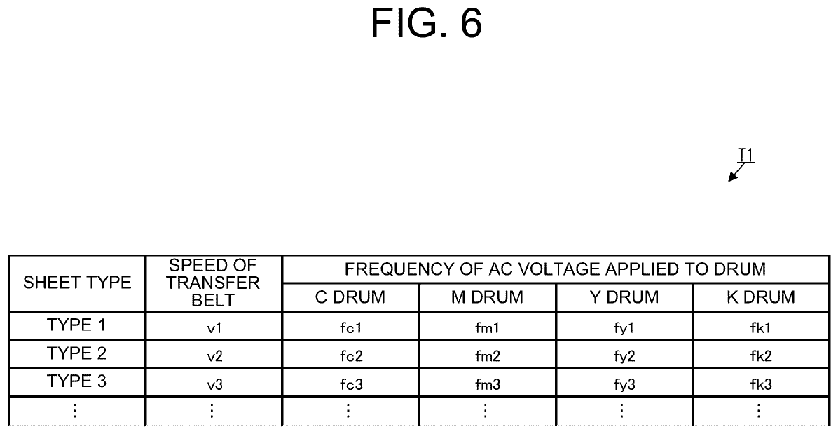

FIG. 6 is a diagram for explaining an example of a structure of the sheet type setting table T1 stored in the sheet type setting storage 110-1. In the sheet type setting table T1, a speed at which the primary transfer belt 170H is driven by the driver 170J, and a frequency of an AC voltage applied to each photosensitive drum, which is the C photosensitive drum 170B, the M photosensitive drum 170C, the Y photosensitive drum 170D, and the K photosensitive drum 170E by the charger 170F are stored according to the sheet type. The sheet type setting table T1 is set in such a way that, for example, in a case where the sheet type is type 1, the primary transfer belt 170H is driven at a speed v1, and AC voltages having frequencies fc1, fm1, fyl, and fk1 are applied to the C photosensitive drum 170B, the M photosensitive drum 170C, the Y photosensitive drum 170D, and the K photosensitive drum 170E in this order. Note that, each value in the sheet type setting table T1 may be configured in such a way that a value set at the time of shipment of the image forming apparatus 10 cannot be changed, or may be configured in such a way that an administrator or the like of the image forming apparatus 10 can change the value via the operation acceptor 130.

### 1.4 Operation

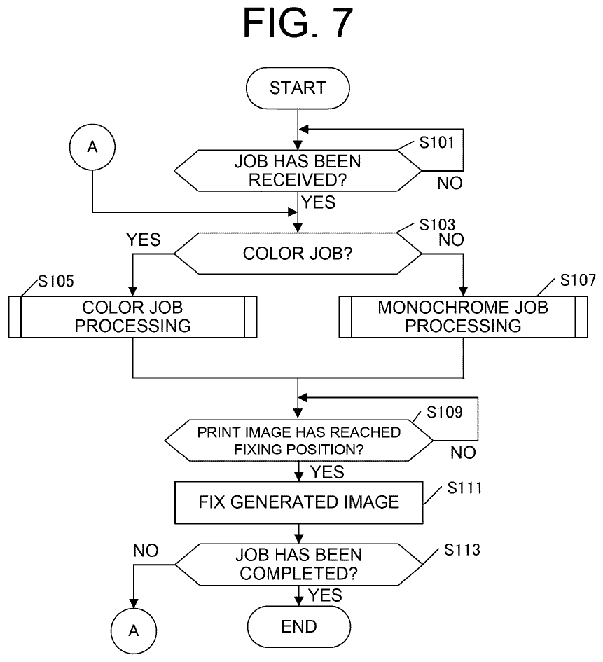

FIG. 7 is a flowchart for describing an operation of the image forming apparatus 10 according to the first embodiment of the present disclosure.

The controller 100 receives a job (S101). Next, the controller 100 determines whether the job is a color job or a monochrome job (S103). In a case where the job is a color job (YES in S103), the controller 100 executes color job processing (S105). In a case where the job is a monochrome job (NO in S103), the controller 100 executes monochrome job processing (S107). When the color job processing or the monochrome job processing is completed, the controller 100 determines whether a print medium on which a print image is formed has reached a fixing position where an unillustrated fixer is disposed (S109). When it is determined that the print medium has reached the fixing position (YES in S109), the controller 100 causes the fixer to fix the print image on the print medium (S111). Next, the controller 100 determines whether the job has been completed (S113). In a case where it is determined that the job has been completed (YES in S113), the controller finishes the processing. In a case where it is determined that the job has not been completed (NO in S113), the controller 100 returns to S103 and continues the processing.

Note that, the fixer includes a heating roller and a pressure roller which are in pressure contact with each other, and heats and pressurizes a sheet by conveying the sheet while sandwiching the sheet at a nip portion between the heating roller and the pressure roller, thereby firmly fixing a toner image formed on a print medium. The print medium on which the toner image has been fixed is discharged to a discharge tray by a discharge roller.

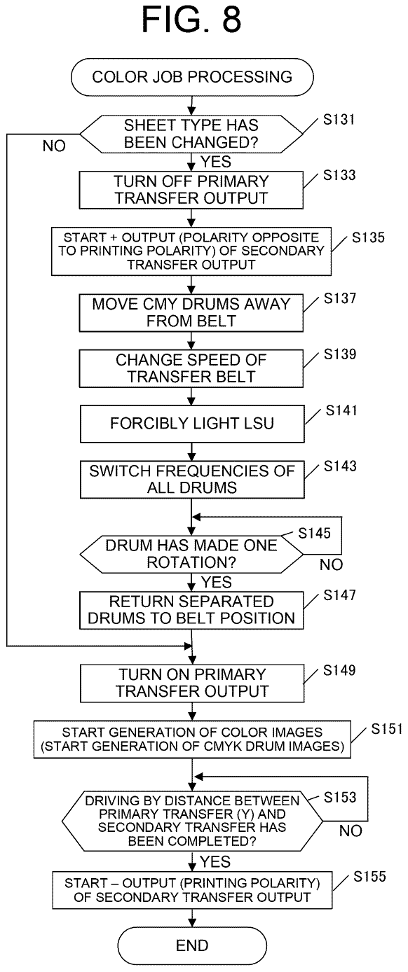

FIG. 8 is a flowchart for describing an operation of color job processing of the image forming apparatus 10 according to the first embodiment of the present disclosure.

The controller 100 determines whether an operation of changing the sheet type has been accepted via the operation acceptor 130 (S131). In a case where the operation of changing the sheet type has been accepted (YES in S131), the controller 100 turns off application of the first potential to the primary transfer belt 170H by the belt potential applier 170K (S133).

Next, the controller 100 starts application of the second potential having the opposite polarity to the secondary transfer roller 170L by using the roller potential applier 170M (S135).

Next, the controller 100 moves the primary transfer belt 170H away from the CMY photosensitive drums by using the CMY drum contact/separator 170G (S137).

Next, the controller 100 reads the speed of the primary transfer belt 170H associated with the sheet type to be changed, which has been accepted in S131, from the sheet type setting table T1 in the sheet type setting storage 110-1, and changes the speed at which the primary transfer belt 170H is driven by the driver 170J to the read speed (S139).

Next, the controller 100 causes the LSU 170A to forcibly emit light (S141). In general, when the driving speed of the primary transfer belt 170H is changed, it is necessary to initialize the LSU, and specifically, it is necessary to cause the LSU to forcibly emit light. Forced lighting of the LSU changes the surface potential of the photosensitive drum. Due to the change in the surface potential, toner irrelevant to an image to be originally formed may adhere to the surface of the photosensitive drum. In this sense, the forced lighting operation of the LSU causes adhesion of toner, which becomes contamination on the photosensitive drum. Hereinafter, the forced lighting operation of the LSU is also referred to as a causal operation. When contamination (toner) adhered to the photosensitive drum is transferred to a print medium by the primary transfer belt 170H and the secondary transfer roller 170L, there is a possibility that contamination irrelevant to the image to be originally formed may be formed on the print medium. The first embodiment prevents this contamination from being formed on a print medium.

Next, the controller 100 changes the frequencies of the high-output AC voltages to be applied to the CMYK photosensitive drums (S143). The frequencies to be changed are frequencies associated with the sheet type to be changed, which has been accepted in S131, in the sheet type setting table S131 in the sheet type setting storage 110-1. In general, when the driving speed of the primary transfer belt 170H is changed, it is necessary to change the frequencies of the high-output AC voltages applied to the photosensitive drums in accordance with the change in the driving speed. When the frequency is changed, a phase shift may occur in the waveform of AC current, which may cause a change in the potential on the surface of the photosensitive drum, and toner irrelevant to an image to be originally formed may adhere to the surface of the photosensitive drum. In this sense, the operation of changing the frequencies of the high-output AC voltages to be applied to the CMYK photosensitive drums also causes adhesion of toner, which becomes contamination on the photosensitive drums. Therefore, hereinafter, the frequency changing operation is also referred to as a causal operation.

Returning to the description on the flowchart, next, the controller 100 determines whether all the drums have made one rotation after forced lighting of the LSU in S141, and switching of the frequencies of the high-output AC voltages applied to all the drums in S143 have been completed (S145). In a case where all the drums have not yet made one rotation (NO in S145), the controller 100 waits until all the drums make one rotation. In a case where all the drums have made one rotation (YES in S145), the controller 100 returns the primary transfer belt 170H to the position where the primary transfer belt 170H is in contact with the CMY photosensitive drums by using the CMY drum contact/separator 170G (S147).

Next, the controller 100 turns on application of the first potential to the primary transfer belt 170H by the belt potential applier 170K (S149).

Next, the controller 100 starts generation of latent images on the CMYK photosensitive drums by using the LSU 170A (S151).

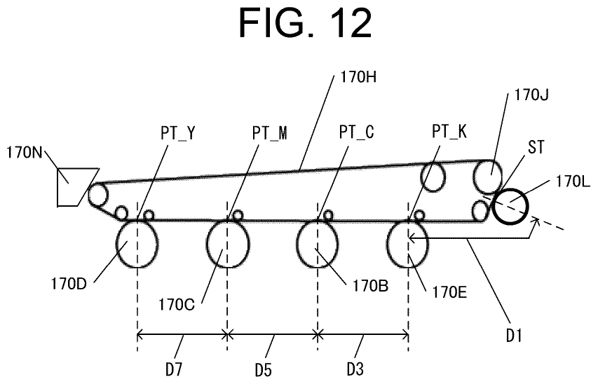

Next, the controller 100 determines whether the primary transfer belt 170H has been driven by using the driver 170J by a distance corresponding to the distance from the primary transfer (Y) position to the secondary transfer position after start of generation of the color image in S151 (S153). The primary transfer (Y) position is a position (PT_Y in FIG. 12) at which the primary transfer belt 170H faces the Y photosensitive drum 170D. The secondary transfer position is a position (ST in FIG. 10) at which the primary transfer belt 170H faces the secondary transfer roller 170L. The distance from the primary transfer (Y) position to the secondary transfer position is a distance corresponding to the length of the primary transfer belt 170H from the position PT_Y to the position ST. The primary transfer position is also referred to as a first transfer position. The secondary transfer position is also referred to as a second transfer position. The primary transfer (Y) position, the secondary transfer position and the like will be described later in detail with reference to FIG. 12. In a case where the primary transfer belt 170H has not been driven by the distance corresponding to the distance from the primary transfer (Y) position to the secondary transfer position (NO in S153), the controller 100 waits, and in a case where the primary transfer belt 170H has been driven (YES in S153), the controller 100 proceeds to the next step.

Next, the controller 100 starts applying the second potential having the printing polarity to the secondary transfer roller 170L by using the roller potential applier 170M (S155).

In S131, in a case where the operation of changing the sheet type has not been accepted (NO in S131), the controller 100 proceeds to S149.

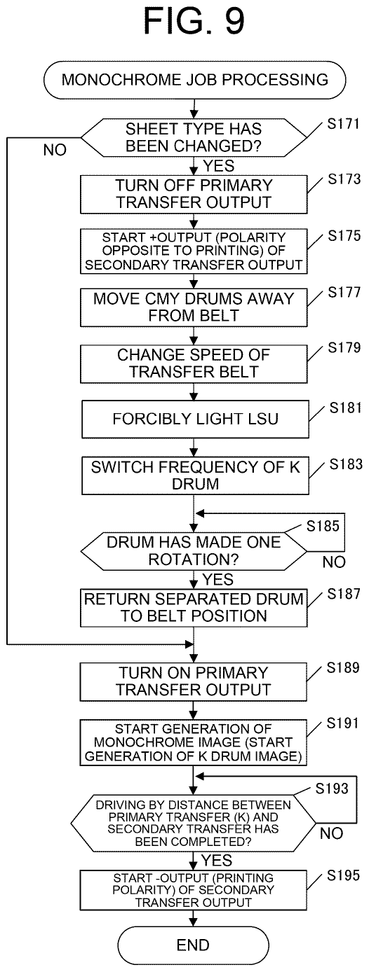

FIG. 9 is a flowchart for describing monochrome job processing of the image forming apparatus 10 according to the first embodiment of the present disclosure.

Processing from S171 to S187 is the same as that from S131 to S147 in the above-described color job processing except for S183. In S143, the frequencies of the AC voltages applied to all the drums have been changed, but in S183, the frequency of the AC voltage applied to the K photosensitive drum 170E is changed.

Next, the controller 100 turns on application of the first potential to the primary transfer belt 170H by the belt potential applier 170K (S189).

Next, the controller 100 starts generation of a latent image on the K photosensitive drum 170E by using the LSU 170A (S191).

Next, the controller 100 determines whether the primary transfer belt 170H has been driven by using the driver 170J by a distance corresponding to the distance from the primary transfer (K) position to the secondary transfer position after start of generation of the monochrome image in S191 (S193). The primary transfer (K) position is a position (PT_K in FIG. 12) at which the primary transfer belt 170H faces the K photosensitive drum 170E. The secondary transfer position is a position (ST in FIG. 12) at which the primary transfer belt 170H faces the secondary transfer roller 170L. The distance from the primary transfer (K) position to the secondary transfer position is a distance corresponding to the length of the primary transfer belt 170H from the position PT_K to the position ST. The primary transfer (K) position, the secondary transfer position and the like will be described later in detail with reference to FIG. 12. In a case where the primary transfer belt 170H has not been driven by the distance corresponding to the distance from the primary transfer (K) position to the secondary transfer position (NO in S193), the controller 100 waits. In a case where the primary transfer belt 170H has been driven (YES in S193), the controller 100 proceeds to the next step.

Next, the controller 100 starts applying the second potential having the printing polarity to the secondary transfer roller 170L by using the roller potential applier 170M (S195).

### 1.5 Operation Example

FIGS. 10A and 10B are conceptual schematic diagrams for explaining a contact/separation operation of the CMY photosensitive drums in the image forming apparatus 10 according to the first embodiment of the present disclosure. FIG. 10A illustrates a state in which the CMY drum contact/separator 170G brings the C photosensitive drum 170B, the M photosensitive drum 170C, and the Y photosensitive drum 170D to come into contact with the primary transfer belt 170H. On the other hand, FIG. 10B illustrates a state in which the CMY drum contact/separator 170G brings the C photosensitive drum 170B, the M photosensitive drum 170C, and the Y photosensitive drum 170D to be away from the primary transfer belt 170H.

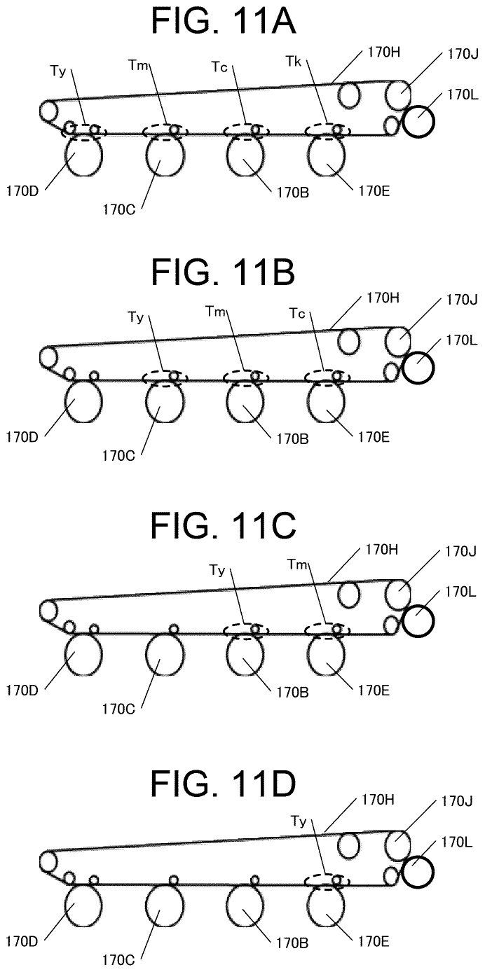

FIGS. 11A to 11D are conceptual diagrams for explaining transfer of a streak adhering to the primary transfer belt 170H from the CMYK photosensitive drums in the image forming apparatus 10 according to the first embodiment of the present disclosure.

FIG. 11A illustrates a section of the primary transfer belt 170H to which toner that becomes streak contamination adheres from the CMYK photosensitive drums immediately after switching of frequencies of high-output AC voltages applied to the photosensitive drums or forced lighting of the LSU 170A. As illustrated in FIG. 11A, toner adheres to the primary transfer belt 170H from the Y photosensitive drum 170D to a section Ty, from the M photosensitive drum 170C to a section Tm, from the C photosensitive drum 170B to a section Tc, and from the K photosensitive drum 170E to a section Tk.

FIG. 11B illustrates positions of the sections Ty, Tm, and Tc when the primary transfer belt 170H is driven in the forward direction from the state in FIG. 11A. In FIG. 11B, the section Ty shifts to a position facing the M photosensitive drum 170C. Likewise, the section Tm shifts to a position facing the C photosensitive drum 170B, and the section Tc shifts to a position facing the K photosensitive drum 170E.

FIG. 11C illustrates positions of the sections Ty and Tm when the primary transfer belt 170H is further driven in the forward direction from the state in FIG. 11B. In FIG. 11C, the section Ty shifts to a position facing the C photosensitive drum 170B. Likewise, the section Tm shifts to a position facing the K photosensitive drum 170E.

FIG. 11D illustrates a position of the section Ty when the primary transfer belt 170H is further driven in the forward direction from the state in FIG. 11C. In FIG. 11D, the section Ty shifts to a position facing the K photosensitive drum 170E.

As can be seen from comparison among FIGS. 11A to 11D, the sections Tk, Tc, Tm, and Ty on the primary transfer belt 170H to which toner adheres by switching of frequencies of high-output AC voltages applied to the CMYK photosensitive drums, or forced lighting of the LSU 170A pass through the secondary transfer roller 170L in this order. In other words, when the section Ty passes through the secondary transfer roller 170L, all the sections Tk, Tc, Tm, and Ty pass through the secondary transfer roller 170L.

FIG. 12 is a schematic conceptual diagram for explaining a relationship among a distance by which the primary transfer belt 170H is idly rotated, the primary transfer positions PT_Y, PT_M, PT_C, and PT_K, and the secondary transfer position ST in the image forming apparatus 10 according to the first embodiment of the present disclosure. Idle rotation of the primary transfer belt 170H means that circularly moving the primary transfer belt 170H on the secondary transfer roller 170L without a purpose of transferring toner from the primary transfer belt 170H to a sheet, and more specifically, means that circularly moving the primary transfer belt 170H in a state in which the printing polarity is not applied to the secondary transfer roller 170L. The state in which the printing polarity is not applied to the secondary transfer roller 170L may be a state in which the second potential is not applied to the secondary transfer roller 170L, but is preferably, for example, a state in which a reverse potential is applied to the secondary transfer roller 170L as in a period from S135 to S155 in FIG. 8.

The primary transfer positions PT_Y, PT_M, PT_C, and PT_K are positions at which the primary transfer belt 170H faces the Y photosensitive drum 170D, the M photosensitive drum 170C, the C photosensitive drum 170C, and the K photosensitive drum 170E in this order. The secondary transfer position ST is a position at which the primary transfer belt 170H faces the secondary transfer roller 170L.

A distance D1 is a distance between the secondary transfer position ST and the primary transfer position PT_K on the primary transfer belt 170H. A distance D3 is a distance between the primary transfer position PT_K and the primary transfer position PT_C on the primary transfer belt 170H0. A distance D5 is a distance between the primary transfer position PT_C and the primary transfer position PT_M on the primary transfer belt 170H. A distance D7 is a distance between the primary transfer position PT_M and the primary transfer position PT_Y on the primary transfer belt 170H.

As described above with reference to FIGS. 11A to 11D, when the section Ty passes through the secondary transfer roller 170L, all of the sections Tk, Tc, Tm, and Ty pass through the secondary transfer roller 170L. As can be seen from FIG. 12, when the primary transfer belt 170H is moved in the forward direction by a distance Dx=D1+D3+D5+D7, the primary transfer belt 170H passes through the secondary transfer roller 170L. After passing through the secondary transfer roller 170L, when the primary transfer belt 170H is further moved in the forward direction, toner adhering to each section is removed by the belt cleaner 170N. Therefore, when the primary transfer belt 170H is moved in the forward direction by the distance Dx=D1+D3+D5+D7 after switching the frequencies of the high-output AC voltages applied to the photosensitive drums, or forced lighting of the LSU 170A, it is possible to avoid toner adhering to the primary transfer belt 170H due to switching of the frequencies of the high-output AC voltages applied to the photosensitive drums, or forced lighting of the LSU 170A from adhering to a print medium by the secondary transfer roller 170L.

### 1.6 Advantageous Effects

In the image forming apparatus 10 according to the first embodiment, the following advantageous effects can be acquired.

### 1.6.1 Advantageous Effect 1

According to the first embodiment, before an operation (forced lighting of the LSU in S141 and S181, changing the frequencies of the AC voltages applied to the photosensitive drums in S143 and S183, hereinafter, collectively referred to as a causal operation) of adhering toner, which becomes a cause of streak contamination on the CMYK photosensitive drums is performed, the CMY photosensitive drums are moved away from the primary transfer belt 170H, the CMYK photosensitive drums are made one rotation, and thereafter, the CMY photosensitive drums are brought into contact with the primary transfer belt 170H again. Therefore, it is possible to avoid toner adhering to the CMY photosensitive drums due to the causal operation from transferring to the primary transfer belt 170H.

### 1.6.2 Advantageous Effect 2

Further, before the causal operation is performed, application of the first potential to the primary transfer belt 170H is turned off, the causal operation is performed, and after the CMYK photosensitive drums are made one rotation, application of the first potential to the primary transfer belt 170H is turned on. Therefore, even when toner adheres to the CMYK photosensitive drums, it is possible to prevent the toner from transferring from the CMYK photosensitive drums to the primary transfer belt 170H.

### 1.6.3 Advantageous Effect 3

Further, before the causal operation is performed, the second potential having the polarity opposite to the printing polarity is applied to the secondary transfer roller 170L, and after all the sections Tk, Tc, Tm, and Ty on the primary transfer belt 170H facing the CMYK photosensitive drums at the timing of performing the causal operation have passed through the secondary transfer roller 170L, the second potential having the printing polarity is applied to the secondary transfer roller 170L. Therefore, even when toner adheres to the primary transfer belt 170H due to the causal operation, the second potential having the opposite polarity and applied to the secondary transfer roller 170L can prevent the toner from transferring from the primary transfer belt 170H to the secondary transfer roller 170L, thereby preventing toner contamination on a print medium by the secondary transfer roller 170L.

### 1.7 Modification of First Embodiment

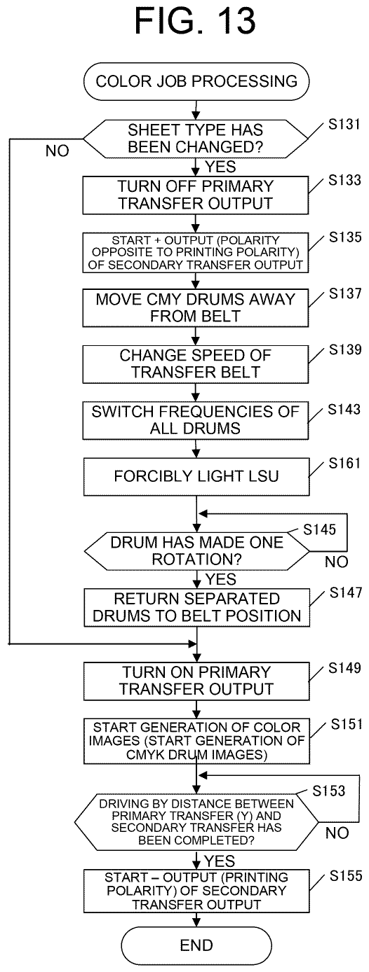

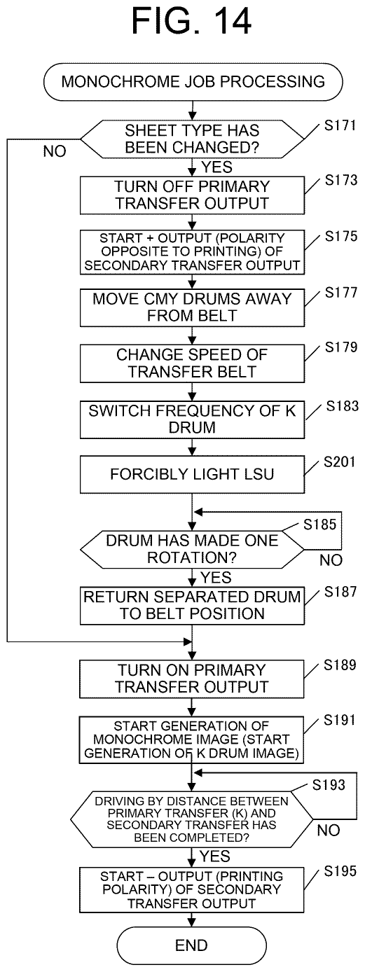

FIG. 13 is a flowchart for describing color job processing of an image forming apparatus 10 according to a modification of the first embodiment of the present disclosure. FIG. 14 is a flowchart for describing monochrome job processing of the image forming apparatus 10 according to the modification of the first embodiment of the present disclosure. As compared with the color job processing and the monochrome job processing in FIGS. 8 and 9, the order of forced lighting of the LSU, and changing frequencies of AC voltages applied to photosensitive drums is reversed, but the advantageous effect is the same.

### 2. Second Embodiment

An image forming apparatus 10 according to a second embodiment is described. Herein, the second embodiment is described mainly on a difference between the first embodiment and the second embodiment. Description on the same parts as those in the first embodiment is omitted.

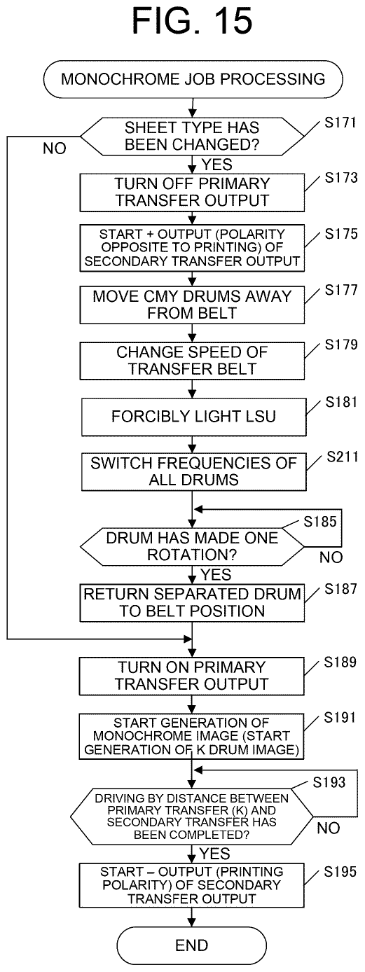

FIG. 15 is a flowchart for describing monochrome job processing of the image forming apparatus 10 according to the second embodiment of the present disclosure. As in the first embodiment, the image forming apparatus according to the second embodiment includes a CMY drum contact/separator 170G capable of moving a C photosensitive drum 170B, an M photosensitive drum 170C, and a Y photosensitive drum 170D toward or away from a primary transfer belt 170H. Further, unlike the first embodiment, in the second embodiment, frequencies of high-output AC voltages applied to the C photosensitive drum 170B, the M photosensitive drum 170C, and the Y photosensitive drum 170D are not different from a frequency of a high-output AC voltage applied to a K photosensitive drum 170E (the same frequency is set).

In the first embodiment, since the frequencies of the AC voltages applied to the CMY photosensitive drums, and the frequency of the AC voltage applied to the K photosensitive drum 170E are independent of each other, only the frequency of the high-output AC voltage applied to the K photosensitive drum 170E is switched in S183 in FIG. 9. In contrast, in the second embodiment, since the frequencies of the AC voltages applied to the CMYK photosensitive drums are common, in S211, the frequencies of the AC voltages applied not only to the K photosensitive drum 170E but also to all the drums are changed.

In the second embodiment, the same advantageous effects as those in the first embodiment can be acquired.

### 3. Third Embodiment

An image forming apparatus 10 according to a third embodiment is described. The third embodiment is described mainly on a difference between the first embodiment and the third embodiment. Description on the same parts as those in the first embodiment is omitted. Although the image forming apparatus 10 according to the first embodiment includes the image former 170, the image forming apparatus 10 according to the third embodiment includes an image former 180 in place of the image former 170.

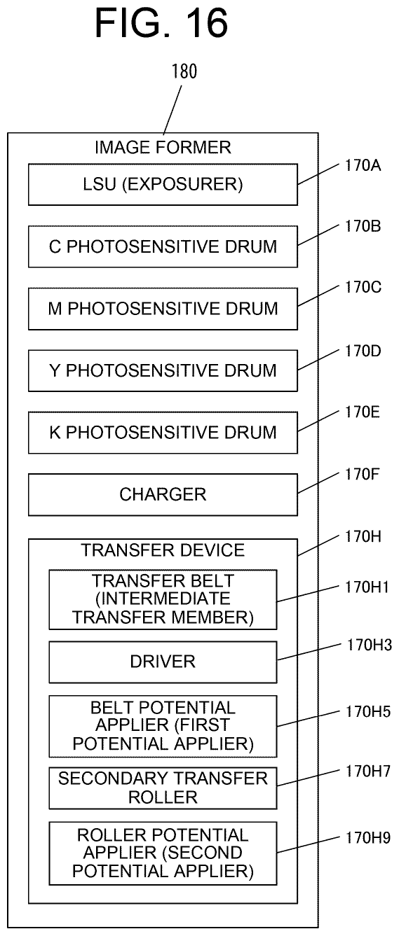

FIG. 16 is a block diagram of the image former 180 of the image forming apparatus 10 according to the third embodiment of the present disclosure. As compared with the image former 170 in the first embodiment, the third embodiment is different in that a CMY drum contact/separator 170G is not provided. In the third embodiment, all the drums are constantly in contact with a primary transfer belt 170H. Further, as in the first embodiment, frequencies of high-output AC voltages applied to a C photosensitive drum 170B, an M photosensitive drum 170C, and a Y photosensitive drum 170D, and a frequency of a high-output AC voltage applied to a K photosensitive drum 170E are different from each other (can be set independently of each other).

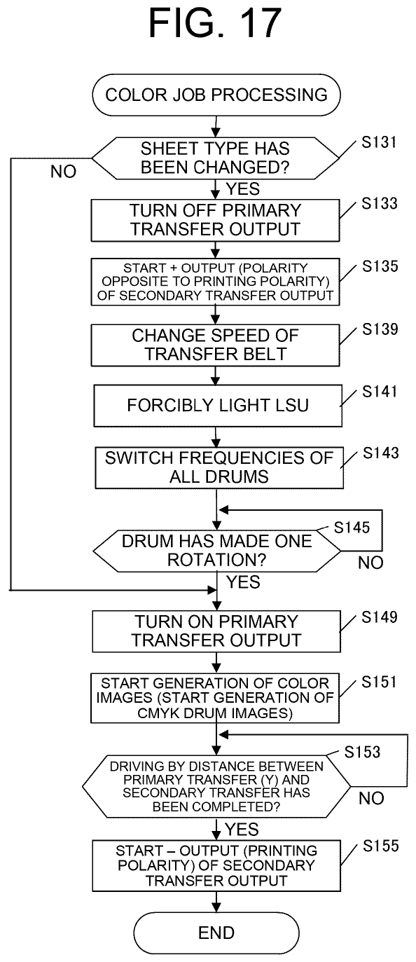

FIG. 17 is a flowchart for describing color job processing of the image forming apparatus 10 according to the third embodiment of the present disclosure. As compared with the color job processing (FIG. 8) in the first embodiment, the third embodiment is different in that “move the CMY drums away from the belt” (S137), and “return the separated drums to the belt position” (S147) are not provided.

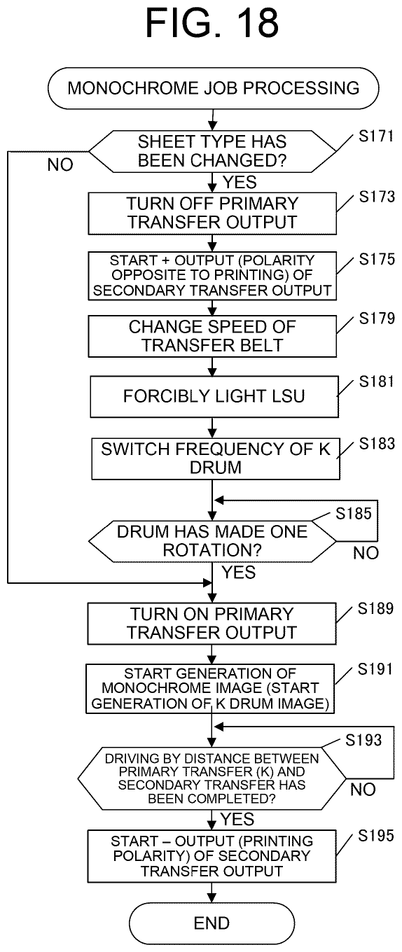

FIG. 18 is a flowchart for describing monochrome job processing of the image forming apparatus 10 according to the third embodiment of the present disclosure. As compared with the monochrome job processing (FIG. 9) in the first embodiment, the third embodiment is different in that “move the CMY drums away from the belt” (S177) and “return the separated drums to the belt position” (S187) are not provided.

According to the first embodiment, performing a contact/separation operation of moving the CMY photosensitive drums away from the primary transfer belt 170H before a causal operation is performed, and returning the CMY photosensitive drums to the position where the CMY photosensitive drums are in contact with the primary transfer belt 170H after the causal operation is performed enables to avoid toner adhering to the CMY photosensitive drums due to the causal operation from transferring to the primary transfer belt 170H (advantageous effect 1).

In contrast, in the third embodiment, the advantageous effect 2 acquired by turning off the first potential applied to the primary transfer belt 170H before and after the causal operation, and the advantageous effect 3 acquired by reversing the polarity of the second potential applied to the secondary transfer roller 170L before and after the causal operation can also be acquired in the third embodiment, although the advantageous effect 1 cannot be acquired because the CMY drum contact/separator 170G is not provided.

Further, since the CMY drum contact/separator 170G is not provided, the image forming apparatus 10 according to the third embodiment can acquire an advantageous effect that it is easy to reduce the size and the height of the image forming apparatus 10 as compared with the first embodiment.

### 4. Fourth Embodiment

An image forming apparatus 10 according to a fourth embodiment is described. Herein, the fourth embodiment is described mainly on a difference between the first embodiment and the fourth embodiment. Description on the same parts as those in the first embodiment is omitted. As in the third embodiment, the image forming apparatus 10 according to the fourth embodiment includes an image former 180, in place of the image former 170. Further, as in the second embodiment, in the image forming apparatus 10 according to the fourth embodiment, frequencies of high-output AC voltages applied to a C photosensitive drum 170B, an M photosensitive drum 170C, and a Y photosensitive drum 170D are not different from a frequency of a high-output AC voltage applied to a K photosensitive drum 170E (the same frequency is set).

Color job processing of the image forming apparatus 10 according to the fourth embodiment is executed in accordance with the flowchart in FIG. 17 as in the third embodiment.

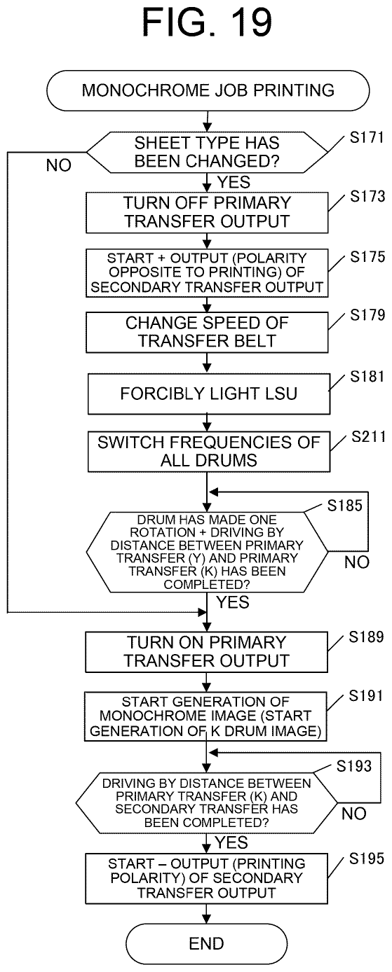

FIG. 19 is a flowchart for describing monochrome job processing of the image forming apparatus 10 according to the fourth embodiment of the present disclosure. As in the monochrome job processing in the third embodiment illustrated in FIG. 18, the flowchart in FIG. 19 does not include “move the CMY drums away from the belt” (S177) and “return the separated drums to the belt position” (S187). Further, as in the monochrome job processing in the second embodiment illustrated in FIG. 15, after forced lighting of the LSU is performed (S181), the frequencies of the high-output AC voltages applied to all the drums are changed (S211).

According to the fourth embodiment, as in the third embodiment, the advantageous effects 2 and 3 can be acquired. Further, according to the fourth embodiment, as in the third embodiment, since a CMY drum contact/separator 170G is not provided, it is easy to reduce the size and the height of the image forming apparatus.

### 5. Fifth Embodiment

An image forming apparatus 10 according to a fifth embodiment is described. The fifth embodiment is described mainly on a difference between the first embodiment and the fifth embodiment. Description on the same parts as those in the first embodiment is omitted.

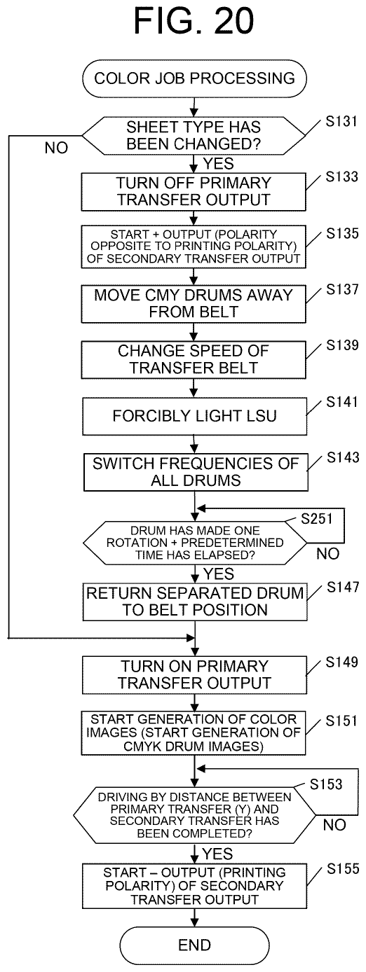

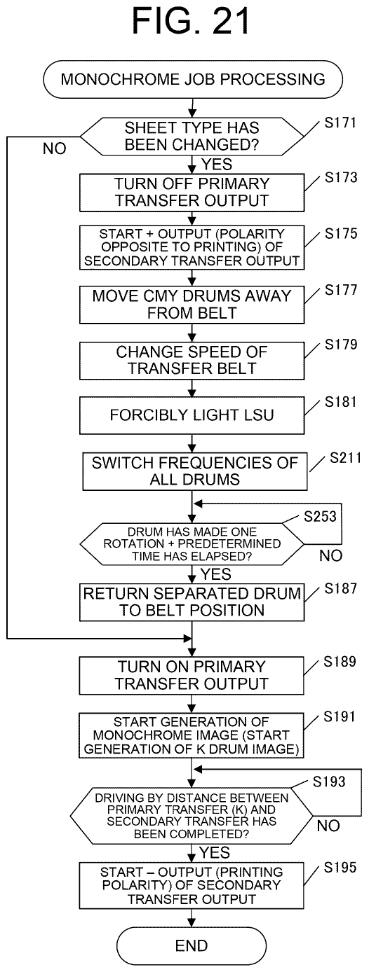

FIG. 20 is a flowchart for describing color job processing of the image forming apparatus 10 according to the fifth embodiment of the present disclosure. FIG. 21 is a flowchart for describing monochrome job processing of the image forming apparatus 10 according to the fifth embodiment of the present disclosure.

In the color job processing (FIG. 8) in the first embodiment, it is determined whether all the drums have made one rotation in S145. In contrast, in the color job processing in the fifth embodiment, in S251 associated with S145, it is determined whether all the drums have made one rotation, and a predetermined time has elapsed. Likewise, in the monochrome job processing (FIG. 9) in the first embodiment, it is determined whether all the drums have made one rotation in S185, but in the color job processing in the fifth embodiment, in S251 associated with S185, it is determined whether all the drums have made one rotation, and a predetermined time has elapsed.

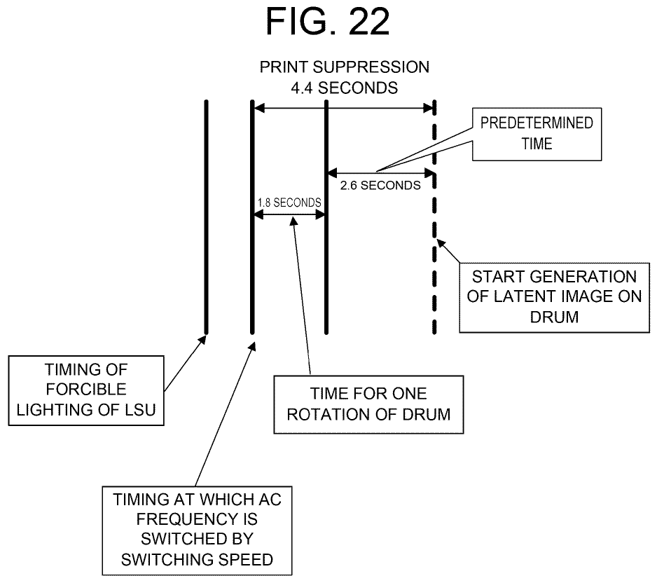

FIG. 22 is a schematic conceptual diagram for describing an example of an elapse of time until transfer from CMYK photosensitive drums to a primary transfer belt 170H is started after performing a last causal operation in the image forming apparatus 10 according to the fifth embodiment of the present disclosure. In the fifth embodiment, as in the first embodiment, forced lighting of the LSU is performed first, and changing frequencies of high-output AC voltages to be applied to the photosensitive drums is performed later.

In this case, for example, 1.8 seconds are required for the last causal operation, that is, until all the drums are made one rotation after changing the frequencies of the high-output AC voltages applied to the photosensitive drums is performed. In the first to fourth embodiments, after the drums are made one rotation, formation of a latent image is started on each of the CMYK photosensitive drums (for example, S151 in FIG. 8). In contrast, in the fifth embodiment, after all the drums are made one rotation, the primary transfer belt 170H is further circularly moved for a predetermined time (2.6 seconds in this example), and thereafter, formation of a latent image is started on each of the CMYK photosensitive drums. Consequently, in the example in FIG. 22, formation of a latent image is started on the CMYK photosensitive drums after an elapse of 4.4 seconds since the frequencies of the high-output AC voltages applied to the photosensitive drums are changed.

The predetermined time is set, for example, by an administrator or the like of the image forming apparatus 10 via an operation acceptor 130, and stored in a storager 110. As in the first to fourth embodiments, even when a latent image is formed on a photosensitive drum immediately after the photosensitive drum is made one rotation after a last causal operation is performed, in a case where the primary transfer belt 170H and the photosensitive drum are constantly in pressure contact with each other without a separation mechanism, even when the advantageous effect 2 acquired by turning off the first potential applied to the primary transfer belt 170H before and after the causal operation, and the advantageous effect 3 acquired by reversing the polarity of the second potential applied to the secondary transfer roller 170L before and after the causal operation are acquired, toner contamination due to a change in the surface potential on the photosensitive drum may spread from the primary transfer belt 170H to the secondary transfer roller 170L, which may cause contamination on the secondary transfer roller 170L, and may cause appearance of streak contamination on a print medium. In such a case, in the fifth embodiment, since contamination on the secondary transfer roller 170L can be cleaned by idle rotation for the predetermined time, the administrator or the like of the image forming apparatus 10 can reduce streak contamination by setting an appropriate predetermined time.

The predetermined time may be a positive value or a negative value. Specifically, after a photosensitive drum is made one rotation, formation of a latent image on the photosensitive drum may be started after a predetermined time has further elapsed (in a case where the predetermined time is a positive value), or formation of a latent image on the photosensitive drum may be started after a time shorter than the time for one rotation of the photosensitive drum has elapsed (in a case where the predetermined time is a negative value). Waiting for formation of a latent image for a time for one rotation of the photosensitive drum is merely an example. Actually, even when formation of a latent image is started without waiting for one rotation of the photosensitive drum, a situation in which streak contamination is not generated occurs. In such a situation, setting the predetermined time to a negative time enables to shorten the time required for printing.

### 6. Sixth Embodiment

An image forming apparatus 10 according to a sixth embodiment is described. The sixth embodiment is described mainly on a difference between the fifth embodiment and the sixth embodiment. Description on the same parts as those in the fifth embodiment is omitted.

In the fifth embodiment, a predetermined time to be further added after all the drums are made one rotation is set in advance as a constant by the administrator or the like. In contrast, in the sixth embodiment, the predetermined time is handled as a variable. The following methods for determining the predetermined time are conceived. Note that, the following determination methods may be used alone or in combination.

### Method 1 for Determining Predetermined Time

The controller 100 computes the predetermined time in accordance with a speed at which the primary transfer belt 170H is circularly moved. For example, the predetermined time may be computed in inverse proportion to the moving speed of the primary transfer belt 170H. Specifically, when the moving speed is 200 mm/s, 2.6 seconds are set, and when the moving speed is 100 mm/s, 5.2 seconds, which is twice as long the above moving speed, are set.

### Method 2 for Determining Predetermined Time

The controller 100 determines the predetermined time depending on whether a print job (next registered print job) that is registered to be executed next to the print job currently being executed is set as color printing or monochrome printing. When the predetermined time in a case where the next registered print job is set as color printing is referred to as a color predetermined time, and the predetermined time in a case where the next registered print job is set as monochrome printing is referred to as a monochrome predetermined time, the color predetermined time is determined to be longer than the monochrome predetermined time. This is because whereas in a case where the next registered print job is color printing, an influence of toner contamination appears for four colors (CMYK), in a case where the next registered print job is monochrome printing, an influence of toner contamination only appears for one color (K), and therefore, toner contamination can be avoided within a shorter predetermined time. Specifically, for example, the color predetermined time may be set to 2.6 seconds, and the monochrome predetermined time may be set to 2.0 seconds.

### Method 3 for Determining Predetermined Time

The predetermined time is set according to the type of a print medium set in the next registered print job. This is based on the fact that susceptibility to toner contamination varies depending on the type of a print medium. When susceptibility to toner contamination is compared, for example, glossy paper is more likely to be affected by toner contamination than plain paper. Therefore, in the next registered print job, the controller 100 sets the predetermined time to be long in a case where the glossy paper is set as a print medium, and sets the predetermined time to be short in a case where the plain paper is set. Specifically, the predetermined time may be set to 5.0 seconds in a case where the print medium is glossy paper, and the predetermined time may be set to 2.6 seconds in a case where the print medium is plain paper.

### Method 4 for Determining Predetermined Time

The predetermined time is determined depending on an external environment such as a temperature and a humidity of the image forming apparatus 10. This is a method based on the fact that properties of toner change depending on a temperature and a humidity, and the degree of toner contamination is large in a high-temperature and high-humidity environment. The predetermined time is set to be longer in the high-temperature and high-humidity environment than in a normal environment. For example, in a case where the vicinity of the image forming apparatus 10 is in a normal environment (for example, the temperature is less than 30° C. or the humidity is less than 70%), the predetermined time is set to 2.6 seconds, and in a case of a high-temperature and high-humidity environment (for example, the temperature is 30° C. or more and the humidity is 70% or more), the predetermined time is set to 4.0 seconds.

Note that, in a case where the present method is used, the image forming apparatus 10 further includes a temperature and humidity sensor for measuring a temperature and a humidity inside and/or in the vicinity of the image forming apparatus 10, and the controller 100 sets the length of the predetermined time in accordance with an output of the temperature and humidity sensor.

### Method 5 for Determining Predetermined Time

The predetermined time is determined depending on an event (causal operation) of streak contamination. In the fifth embodiment, the value of the predetermined time is determined based on a premise that both of forced lighting of the LSU (for example, S141 in FIG. 20), and changing the frequencies of the high-output AC voltages applied to the photosensitive drums (for example, S143 in FIG. 20) are performed as causal operations. In other words, in the fifth embodiment, the causal operations are not individually handled, and one predetermined time is collectively determined. In contrast, in the present method, a time is determined in advance for each causal operation, and the total time of the executed causal operations is determined as the predetermined time. For example, the time for forced lighting of the LSU is set to 2.6 seconds, and the time for changing the frequencies of the high-output AC voltages applied to the photosensitive drums is set to 3.8 seconds. In this way, the predetermined time is set individually depending on the event (causal operation) of streak contamination.

According to the sixth embodiment, it is possible to set an appropriate length of predetermined time.

### 7. Seventh Embodiment

An image forming apparatus 10 according to a seventh embodiment is described. The seventh embodiment is described mainly on a difference between the first embodiment and the seventh embodiment. Description on the same parts as those in the first embodiment is omitted.

In the image forming apparatus 10 according to the seventh embodiment, in a controller 100, a driver 170J can drive a primary transfer belt 170H both in a circulation direction (forward direction) of a primary transfer belt 170H at the time of printing, and in a circulation direction (reverse direction) opposite to the forward direction.

In the seventh embodiment, after the last causal operation is performed, the primary transfer belt 170H is circularly moved in the reverse direction for a predetermined time, and then the circulation direction is returned to the forward direction to start next printing.

The predetermined time during which the primary transfer belt 170H is circularly moved in the reverse direction is preferably a period of time sufficient to remove toner from all points on the primary transfer belt 170H to which unnecessary toner may have adhered by forced lighting of the LSU and/or changing the frequencies of the AC voltages applied to the photosensitive drums.

In a case where either forced lighting of the LSU or changing the frequencies of the AC voltages to be applied to the photosensitive drums is performed, after all points PT_Y, PT_M, PT_C, and PT_K on the primary transfer belt 170H in contact with CMYK photosensitive drums at that time pass through a belt cleaner 170N for removing toner from the primary transfer belt 170H, the circulation direction is returned to the forward direction. For example, in a case where the CMYK photosensitive drums are disposed in the same order as in the above-described embodiments, the circulation direction of the primary transfer belt 170H is changed to the reverse direction until the point PT_K in contact with the K photosensitive drum passes through the belt cleaner 170N at the time when either forced lighting of the LSU or changing the frequencies of the AC voltages applied to the photosensitive drums is performed. Thus, all of the points PT_Y, PT_M, PT_C, and PT_K return to the positions at which they pass through the belt cleaner 170N again when the primary transfer belt 170H is circularly moved in the forward direction. Thereafter, when the circulation direction is returned to the forward direction, since all of the points PT_Y, PT_M, PT_C, and PT_K pass through the belt cleaner 170N, toner adhering to the points PT_Y, PT_M, PT_C, and PT_K is removed.

In a case where both of forced lighting of the LSU, and changing the frequencies of the AC voltages applied to the photosensitive drums are performed, the circulation direction is set to the reverse direction at the time when one of the causal operations is performed first, and the circulation direction is returned to the forward direction, after all of the points PT_Y, PT_M, PT_C, and PT_K on the primary transfer belt 170H in contact with the CMYK photosensitive drums pass through the belt cleaner 170N for removing toner from the primary transfer belt 170H at the time when the other of the causal operations is performed later.

According to the seventh embodiment, even when toner adhering to the CMYK photosensitive drums due to a causal operation transfers to the primary transfer belt 170H, the LSU generates an electrostatic latent image after the belt cleaner 170N removes the toner contamination. Therefore, an advantageous effect of avoiding contamination to a print medium is provided.

### 8. Modification Example

The present disclosure is not limited to the above-described embodiments and modification, and various modifications are available. Specifically, an embodiment acquired by combining appropriately modified technical means within the scope without departing from the gist of the present disclosure is also included in the technical scope of the present disclosure.

In the above-described embodiments, forced lighting of the LSU and changing the frequencies of the high-output AC voltages to be applied to the photosensitive drums have been described as operations of causing toner adhesion which becomes streak contamination on a surface of the photosensitive drums. However, the causal operations may be other operations. An operation in which an instantaneous potential change occurs in the surface potential of a photosensitive drum, and an electrostatic latent image may be formed due to a reason other than the latent image generated by the LSU can be a causal operation.

A program that operates in each device according to the embodiments is a program (a program that causes a computer to function) that controls a CPU or the like in such a way as to achieve the functions according to the above-described embodiments. Information handled by these devices is temporarily stored in a temporary storage device (for example, RAM) at the time of processing, and thereafter, is stored in a storage device such as various read only memories (ROMs), an HDD, or a solid state drive (SSD), and is read, modified, or written by the CPU as necessary.

Herein, the recording medium that stores the program may be any of a semiconductor medium (e.g., a ROM or a nonvolatile memory card), an optical recording medium/magneto-optical recording medium (e.g., a digital versatile disc (DVD), a magneto optical disc (MO), a mini disc (MD), a compact disc (CD), or a Blu-ray (BD) (registered trademark) Disc), a magnetic recording medium (e.g., a magnetic tape or a flexible disk), or the like. Further, not only the functions according to the above-described embodiments are achieved by executing the loaded program, but also the functions according to the present disclosure may be achieved by performing processing in cooperation with an operating system, another application program, or the like, based on instructions of the program.

Further, in a case where the program is distributed in the market, the program can be stored in a portable recording medium and distributed, or can be transferred to a server computer connected via a network such as the Internet. In this case, it is needless to say that a storage device of the server computer is also included in the present disclosure.

What is claimed is:

1. An image forming apparatus comprising:
a photosensitive drum;
an intermediate transfer member;
a driver that drives the intermediate transfer member at a variable driving speed;
a first potential applier that applies a first potential to the intermediate transfer member to transfer a toner image from the photosensitive drum to the intermediate transfer member; and
one or more controllers, wherein
the one or more controllers cause the first potential applier to stop applying the first potential to the intermediate transfer member during a first period that is started based on a timing at which the driver changes a driving speed of the intermediate transfer member, and
the first period is determined based on a period during which the photosensitive drum makes one rotation.

2. The image forming apparatus according to claim 1, further comprising:
a secondary transfer roller; and
a second potential applier that applies a potential to the secondary transfer roller, wherein
the one or more controllers apply a potential having a polarity opposite to a printing polarity to the secondary transfer roller by using the second potential applier during a second period that is started based on a timing at which the driver changes a driving speed of the intermediate transfer member, and apply a potential having the printing polarity to the secondary transfer roller by using the second potential applier after elapse of the second period,
the second period is determined based on the first period and a period required for a point on the intermediate transfer member to be driven from a first transfer position associated with the photosensitive drum to a second transfer position associated with the secondary transfer roller by the driver, and
the printing polarity is a polarity of a potential applied to the secondary transfer roller to transfer the toner image transferred to the secondary transfer roller onto a recording medium.

3. The image forming apparatus according to claim 2, further comprising
a plurality of photosensitive drums disposed in series along a driving direction of the intermediate transfer member, wherein
the first transfer position is associated with a photosensitive drum disposed farthest from the second transfer position among the plurality of photosensitive drums.

4. The image forming apparatus according to claim 1, further comprising
a drum contact/separator that allows the photosensitive drum to move toward or away from the intermediate transfer member, wherein
the one or more controllers move the photosensitive drum away from the intermediate transfer member during the first period by using the drum contact/separator.

5. The image forming apparatus according to claim 1, further comprising
an exposurer that exposes the photosensitive drum, wherein
the one or more controllers cause the exposurer to emit light during the first period to initialize the exposurer.

6. The image forming apparatus according to claim 1, further comprising
a charger that applies an AC voltage to the photosensitive drum, wherein
the one or more controllers change a frequency of an AC voltage applied by the charger during the first period.

7. A control method of an image forming apparatus including
a photosensitive drum,
an intermediate transfer member,
a driver that drives the intermediate transfer member at a variable driving speed, and
a first potential applier that applies a first potential to the intermediate transfer member to transfer a toner image from the photosensitive drum to the intermediate transfer member, the control method comprising:
causing the first potential applier to stop applying the first potential to the intermediate transfer member during a first period that is started based on a timing at which the driver changes a driving speed of the intermediate transfer member, wherein
the first period is determined based on a period during which the photosensitive drum makes one rotation.
